(19) United States
(12) Patent Application Publication
(10) Pub. No.: US 2025/0222865 A1
(43) Pub. Date: Jul. 10, 2025

(54) VEHICULAR VISION SYSTEM WITH RETRACTABLE INTERIOR REARVIEW MIRROR

(71) Applicant: Magna Mirrors of America, Inc., Holland, MI (US)

(72) Inventor: Maxwell E. Ziegler, Grand Rapids, MI (US)

(21) Appl. No.: 19/011,791

(22) Filed: Jan. 7, 2025

Related U.S. Application Data
(60) Provisional application No. 63/618,478, filed on Jan. 8, 2024.

(51) Int. Cl. B60R 1/04; B60R 11/00

(52) U.S. Cl. CPC B60R 1/04; B60R 11/00; B60R 2011/0033; B60R 2011/0045; B60R 2011/0082; B60R 2011/0092; B60R 2300/8066

(57) ABSTRACT

A vehicular mirror system includes an interior rearview mirror assembly having a mirror head that accommodates a mirror reflective element. With the interior rearview mirror assembly mounted at a vehicle, the mirror head is adjustable between a deployed position and a stowed position. A video display screen is disposed within an interior cabin of the vehicle remote from the interior rearview mirror assembly. Responsive to determination that the mirror head is in the stowed position, the video display screen operates to display rearview video images derived from image data captured by a rearward-viewing camera disposed at the vehicle and viewing rearward of the vehicle to provide a rearward view for viewing by a driver of the vehicle.

### CROSS REFERENCE TO RELATED APPLICATION

The present application claims the filing benefits of U.S. provisional application Ser. No. 63/618,478, filed Jan. 8, 2024, which is hereby incorporated herein by reference in its entirety.

### FIELD OF THE INVENTION

The present invention relates generally to the field of interior rearview mirror assemblies for vehicles and to a vehicle vision system for a vehicle and, more particularly, to a vehicle vision system that utilizes one or more cameras at a vehicle.

### BACKGROUND OF THE INVENTION

It is known to provide a mirror assembly that is adjustably mounted to an interior portion of a vehicle, such as via a single ball pivot or joint mounting configuration or double ball pivot or joint mounting configuration, where the mirror head and reflective element are adjusted relative to the interior portion of a vehicle by pivotal movement about the single or double ball pivot configuration. The mirror head and reflective element are pivotable about either or both of the ball pivot joints by a driver that is adjusting the driver's rearward view.

### SUMMARY OF THE INVENTION

A vehicular mirror system includes an interior rearview mirror assembly. The interior rearview mirror assembly includes a mirror head and a mounting structure. The mounting structure is configured to attach at an interior portion of an interior cabin of a vehicle equipped with the vehicular mirror system to mount the interior rearview mirror assembly at the interior portion of the interior cabin of the vehicle. The mirror head is adjustably disposed at the mounting structure. The mirror head accommodates a mirror reflective element. With the interior rearview mirror assembly mounted at the interior portion of the interior cabin of the vehicle, the mirror head is adjustable between an open or deployed or use position, where the mirror reflective element is exposed and viewable by a driver of the vehicle and the mirror head is positioned to provide a rearward view for the driver of the vehicle, and a closed or stowed or non-use position, where the mirror head is moved from the deployed position and toward the mounting structure to conceal the mirror reflective element.

The vehicular mirror system also includes a video display screen disposed within the interior cabin of the vehicle remote from the interior rearview mirror assembly. With the mirror head in the stowed position, the video display screen is electrically operable to display video images representative of the rearward view for viewing by the driver. The vehicular mirror system, responsive to determination that the video display screen is not operating to display video images representative of the rearward view, adjusts the mirror head from the stowed position to the deployed position to provide the rearward view for the driver of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of an interior rearview mirror assembly with a retractable mirror head in an opened or deployed position;

FIG. 3 is a perspective view of the interior rearview mirror assembly of FIG. 2, with the mirror head in a closed or stowed position;

FIG. 4 is a schematic view of the interior rearview mirror assembly of FIG. 2 showing an actuator disposed at a mounting base;

FIG. 5 is a schematic view of a video display screen positioned within an interior cabin of the vehicle remote from the interior rearview mirror assembly; and

FIG. 6 is a schematic view of the interior cabin of the vehicle.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

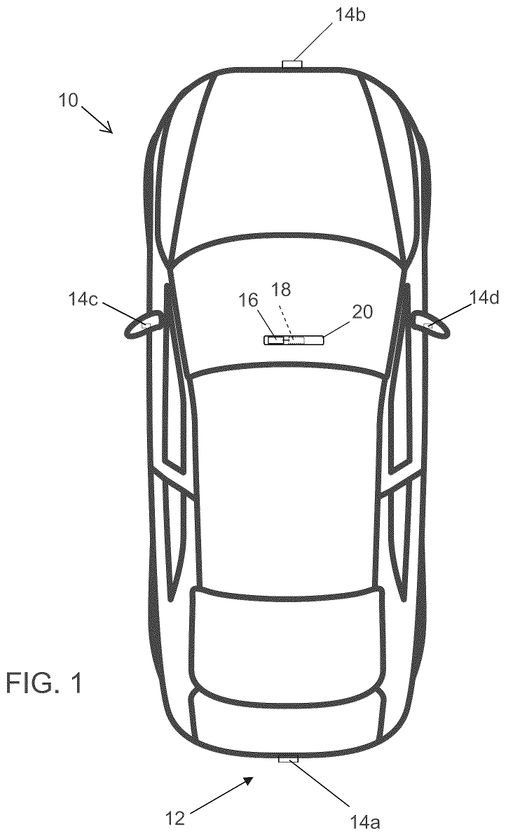

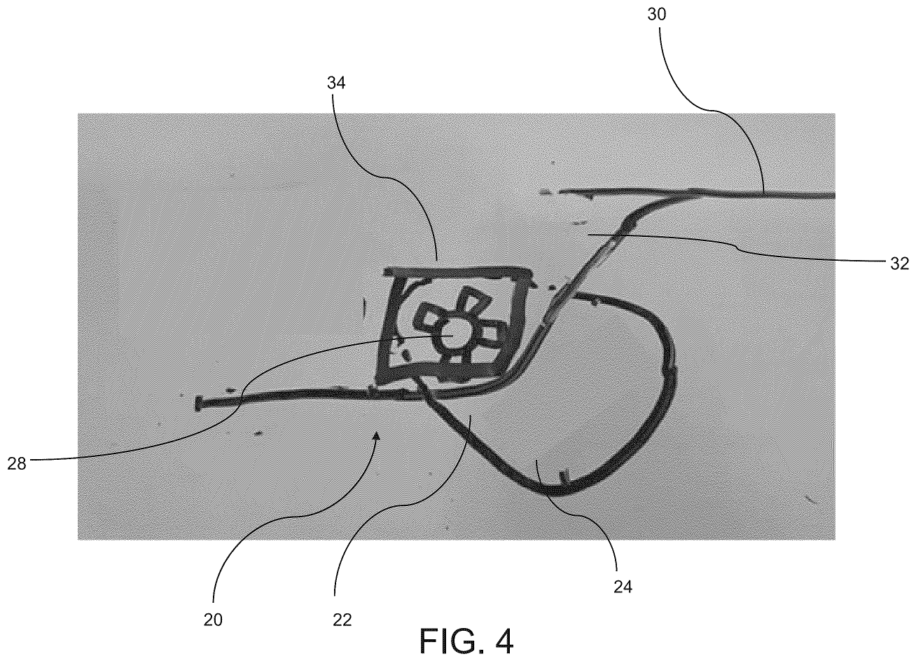

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (FIG. 4). Although shown in FIG. 1 as being part of or incorporated in or at an interior rearview mirror assembly 20 of the vehicle, the control may be disposed elsewhere at or in the vehicle. For example, the display device 16 is disposed at a center stack or center console 36 of the vehicle and the ECU 18 may be disposed at the center stack (FIG. 4). The data transfer or signal communication from the camera to the ECU may comprise any suitable data or communication link, such as a vehicle network bus or the like of the equipped vehicle.

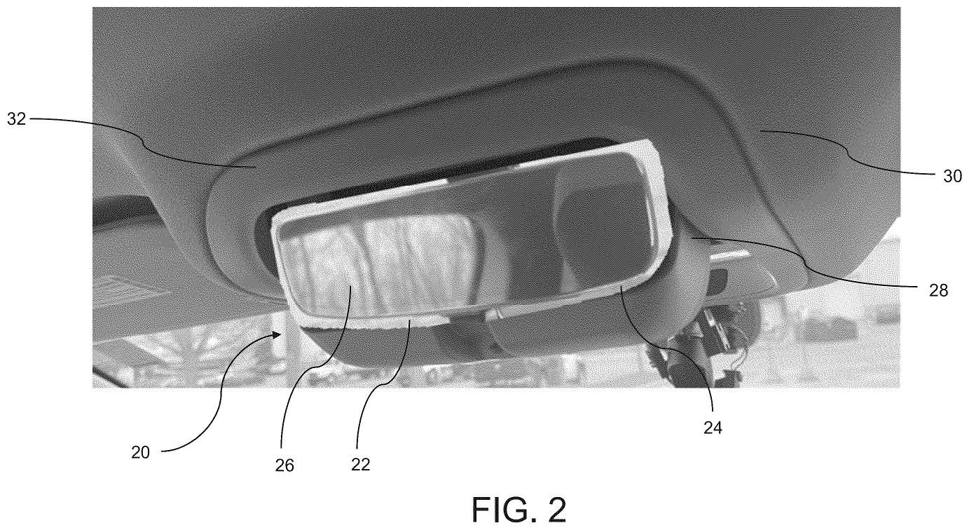

As discussed further below, the interior rearview mirror assembly 20 includes a mirror head 22 that is movable or pivotable or extendable/retractable relative to an interior portion of the vehicle 10 between a stowed position or non-use position, where the mirror head 22 is at least partially hidden or retracted into the interior portion of the vehicle to be out of view of the driver of the vehicle, and a deployed position or extended position or use position, where the mirror head 22 is extended or pivoted outward from the interior portion of the vehicle (FIG. 2). With the mirror head 22 in the extended position, a mirror reflective element 26 of the mirror assembly 20 provides a rearward view to the driver of the vehicle and, at least with the mirror head in the stowed position, the video display screen 16 displays images to the driver of the vehicle representative of the view rearward of the vehicle.

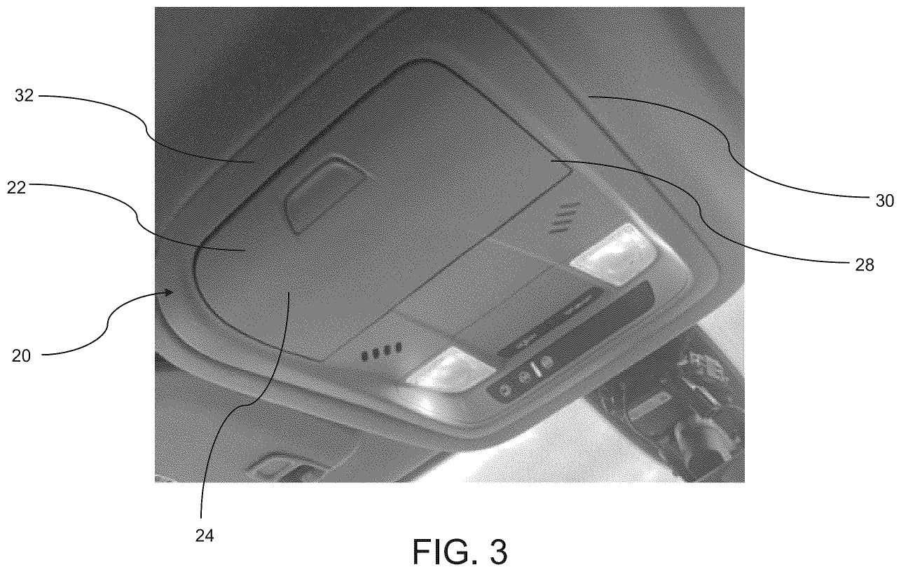

As shown in FIG. 2, the mirror head 22 includes a mirror casing 24 and the mirror reflective element 26. In the illustrated embodiment, the mirror head 22 is configured to be adjustably mounted to an interior portion of a vehicle via a mounting base or mounting configuration or assembly 28. For example, the mounting base 28 may be pivotally disposed at a headliner 30 of the vehicle or an overhead console module 32 attached at the headliner 30. The mirror casing 24 may be attached at the mounting base 28 and/or integrally formed with the mounting base 28 so that the mirror head 22 is adjustable relative to the interior portion of the vehicle via movement of the mounting base 28. As discussed further below, the mirror assembly 20 is adjustable between a closed or stowed position (FIG. 3), where the mounting base 28 and the mirror head 22 are pivoted at least partially upward toward (and optionally within) the interior portion of the vehicle so that the mirror reflective element 26 is not viewable by the driver of the vehicle, and an opened or deployed position (FIG. 2), where the mounting base 28 and the mirror head 22 are pivoted out of and/or away from the interior portion of the vehicle so that the mirror reflective element 26 is exposed and provides the rearward field of view to the driver. That is, in the stowed position the mounting base 28 may be at least partially contained within the overhead console or headliner 30 of the vehicle and the mirror head 22 is adjustable with the mounting base 28 between the stowed and deployed positions. Optionally, the mirror head 22 may be adjustable relative to the mounting base 28 when in the deployed position so that the driver can set the desired rearward view.

When the mirror head 22 is in the deployed position (FIG. 2) with the mirror reflective element 26 exposed and viewable by the driver, the mirror casing 24 and/or at least a portion of the mounting base 28 may extend from and/or below the overhead console 32 and/or the headliner 30. When the mirror head 22 is in the stowed or non-use or non-deployed position (FIG. 3), an outer surface or rear surface of the mirror casing 24 and/or the mounting base 28 may be flush with portions of the headliner 30 and/or overhead console 32 at or near or surrounding the mirror assembly 20. For example, the outer surface of the rear wall of the mirror casing 24 opposite the reflective element 26 may be formed or contoured to correspond with the outer surface of the overhead console 32, so that the mirror head 22 may pivot upward from the deployed position to the stowed position and be received in the overhead console 32 with the outer surface of the rear wall of mirror casing 24 being generally flush or co-planar with the corresponding or adjacent outer surface of the overhead console 32.

The mirror casing 24 accommodates the mirror reflective element 26 and the mirror casing 24 and mirror reflective element 26 move together and in tandem with one another as the mirror head 22 and mounting base 28 are adjusted between the stowed and deployed positions. In some examples, the mirror reflective element 26 and the mirror casing 24 may be fixed or non-movable relative to the mounting base 28 such that the mounting base 28 and mirror head 22 are adjusted together and in tandem to adjust the rearward view when the mirror head 22 is in the deployed position. For example, the mirror reflective element 26 may be adhesively attached to an attachment plate of the mirror head 22 or may be attached at the mirror head 22 via any other suitable means of attachment, with the mirror casing 24 attached to or integrally formed with the mounting base 28.

Optionally, the mirror reflective element 26 and/or the mirror casing 24 may be adjustable relative to the mounting base 28 when the mirror head 22 is in the deployed position. For example, the mirror reflective element 26 may be attached to a mirror backplate that pivotally attaches to the mirror casing 24, such as at a ball-and-socket pivot joint or at an electrically-operable actuator of the mirror head 22, and the mirror backplate and the mirror reflective element 26 may be adjustable relative to the mirror casing 24 to adjust the driver's rearward view. Optionally, the mirror reflective element 26 may be fixed or non-movable relative to the mirror casing 24 with the mirror casing 24 adjustable relative to the mounting base 28 to adjust the rearward view when the mirror head 22 is in the deployed position.

With reference to FIG. 3, when the mirror head 22 is in the stowed position, the mirror reflective element 26 is no longer viewable by the driver and may be hidden by and/or contained within the headliner 30 or overhead console 32. That is, the outer or rear surface of the mirror casing 24 may be flush with the overhead console 32 when in the stowed position.

The mounting base 28 may pivotally attach the mirror head 22 at the headliner 30 and/or overhead console 32 of the vehicle, such as about a pivot axis that extends generally parallel to a longitudinal axis of the mirror head 22 and/or the mirror reflective element 26. The mounting base 28 may pivotally attach to the headliner 30 and/or the overhead console 32 at or near an upper edge portion of the mirror head 22. The mirror head 22 may extend from the interior portion of the cabin of the vehicle to provide the rearward view in the deployed position and the mirror head 22 may be pivoted toward and at least partially within the interior portion of the cabin in the stowed position to be moved out of the forward view of the driver through the windshield. Further, in the deployed position, the mirror reflective element 26 faces rearward and toward the driver of the vehicle and, in the stowed position, the mirror reflective element 26 may face upward toward the headliner 30 and/or the overhead console 32. Thus, the mirror head 22 is pivoted upward toward the headliner when moved to the stowed position and the mirror head 22 is pivoted downward away from the headliner when moved to the deployed position.

The mirror head 22 may be manually movable between the stowed and deployed positions or may be moved via electrical operation of an actuator of the overhead console 32. For example, and such as shown in FIG. 4, an electrically operable actuator 34 includes an electrically operable motor that is operable to move the mirror head 22 between the stowed position and the deployed position. The actuator 34 may be disposed within the overhead console 32 and operate to move the mounting base 28 to move the mirror head 22 between positions. That is, operation of the motor of the actuator 34 (e.g., a stepper motor or the like) may control the pivotal movement of the mirror head 22 between the deployed position and the stowed position. The actuator 34 may be operated to move the mirror head 22 between the stowed position and the deployed position based on an input, such as based on actuation of a user actuatable input at the interior cabin of the vehicle or based on a signal from a vehicular control system or vehicular vision system.

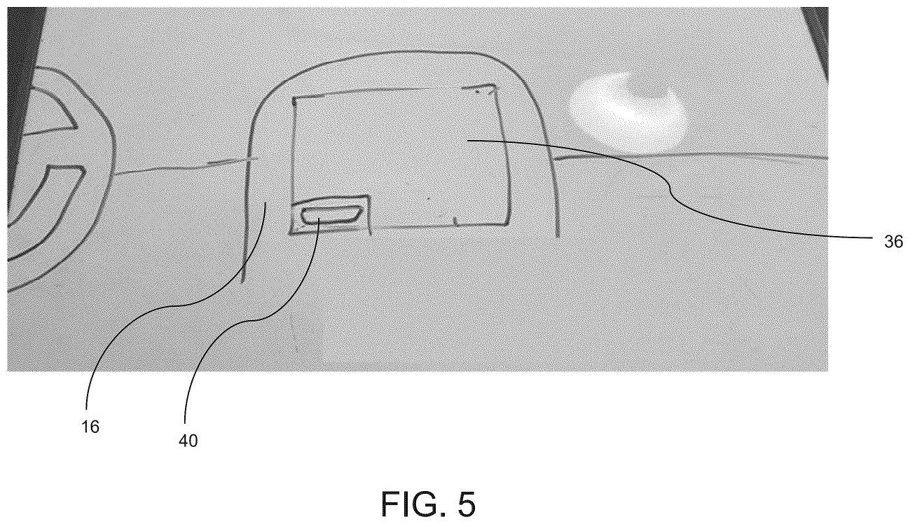

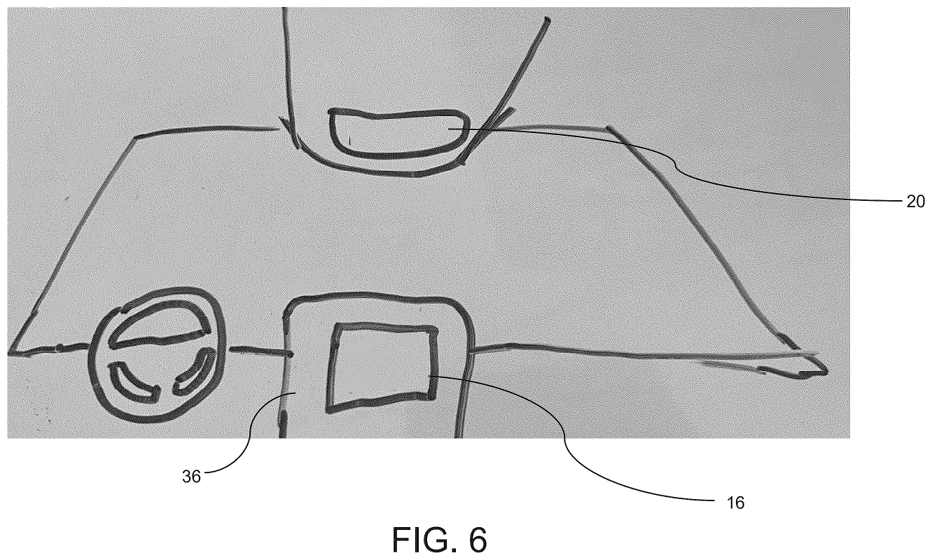

Referring to FIGS. 5 and 6, the center stack or center console or dashboard 36 within the vehicle accommodates the video display screen 16 (e.g., for an infotainment system of the vehicle). During operation of the vehicle, and as the vehicle is travelling along the road or reversing, the video display screen 16 may display video images derived from image data captured by at least one rearward-viewing camera of the vehicle (e.g., a rear backup camera or a plurality of rearward-viewing cameras including side-mounted rearward-viewing cameras and a rear-mounted rearward viewing camera). Thus, the video display screen 16 at the center stack 36 may display a live video feed of the scene rearward of the vehicle, such as representative of the rearward field of view provided by the mirror reflective element 26 of the mirror assembly 20.

Adjustment of the position of the mirror head 22 may be based on the operation of the video display screen 16. For example, with the mirror head 22 in the stowed position (and thus with the mirror reflective element 26 concealed and not providing the rearward view to the driver of the vehicle), the video display screen 16 may be operated to display the video images representative of the rearward field of view. The driver may thus view rearward of the vehicle via the video images at the video display screen 16. When the video display screen 16 is not being operated to display the video images, the mirror head 22 may be moved to the deployed position to provide the rearward field of view. For example, if a situation were to occur that renders the video display screen 16 non-operational, such as due to a technical malfunction, inoperable camera, video failure, damage to the center stack 36, and the like, the mirror head 22 may be moved to the deployed position with the mirror reflective element 26 exposed to provide the rearward view to the driver. In other words, based on determination that the video display screen 16 is not displaying video images, or based on determination that the video images are insufficient to provide the rearward field of view (e.g., due to occlusions at the camera lens or corrupted image data), the actuator 34 may be operated to adjust the mirror head 22 into the deployed position.

Further, to maintain a rearward view for the driver of the vehicle, the driver may be precluded or prevented from manually moving the mirror head 22 from the deployed position into the stowed position when the video display screen 16 is not being operated to display video images. For example, the stepper motor of the actuator 34 may lock the mirror head 22 in the deployed position. The locking feature of the mirror head 22 may be a safety consideration to provide the driver the rearward view when the video display screen 16 is not operational.

Optionally, the mirror head 22 may be moved between the stowed position and the deployed position based on a user input, such as based on a physical button within the interior cabin of the vehicle, an input at the video display screen 16, a voice command, and the like. That is, the driver may turn the video display screen 16 on or off while the mirror head 22 is in the deployed position, but the video display screen 16 remains on and is not shut off while the mirror head 22 is in the closed position and while a gear selector or propulsion system of the vehicle is in a drive or reverse gear or mode (i.e., not in a park gear or mode). For example, a user interface button 40 may be present within the video display screen 16, or at the center stack 36 or dashboard of the vehicle and the like. Based on the input provided by the driver at the user interface button 40, the mirror head 22 is moved between the deployed position and the stowed position. The user interface button 40 may be dedicated to adjusting the mirror head 22 between the deployed position and the stowed position or the user interface button 40 may adjust the display at the video display screen 16 thereby causing a change in the position of the mirror head 22. For example, the user interface button 40 may cause the display screen 16 to stop operating to display rearview images and to start operating to display a graphical user interface for an infotainment system or navigation system of the vehicle.

In some examples, operation of the video display screen 16 may be automatically adjusted based on the position of the mirror head 22 between displaying video images (when the mirror head 22 is in the stowed position) and not displaying video images (when the mirror head 22 is in the deployed position). Optionally, the video display screen 16 may be operated to display video images with the mirror head 22 in either the stowed position or the deployed position, such that a first input at the video display screen 16 may move the mirror head 22 between the deployed and stowed positions and a second input may control operation of the video display screen 16. To maintain a rearward view for the driver, the video display screen may only be deactivated when the mirror head 22 is in the deployed position and movement of the mirror head 22 to the stowed position may automatically activate the video display screen 16.

Optionally, with the mirror head 22 in the deployed position and responsive to detection of an object in the field of view of the rearward-viewing camera, the video display screen 16 may be operated to display the rearward images. For example, the system may display the images to highlight the detected object (e.g., generate a graphical overlay at or near the detected object in the displayed image) or display an alert to the driver related to the detected object.

Thus, the user interface button 40 provides the driver with an option, controlled by actuation of the user interface button 40, to view rearward of the vehicle via the video display screen 16 and/or the mirror reflective element 26. If the driver desires to view rearward of the vehicle using the video display screen 16, the driver may provide the corresponding input via the user interface button 40, and the mirror head 22 may be moved to the stowed position, and the video display screen 16 may be operated to display the video images representative of the rearward field of view. If the driver desires to view rearward of the vehicle via the mirror reflective element 26 of the mirror assembly 20, the driver may provide the corresponding input via the user interface button 40, and the mirror head 22 may be moved to the deployed position, and, optionally, operation of the video display screen 16 may be adjusted to no longer display the video images. With the mirror head 22 in the deployed position, the mirror head 22 may not be manually movable to the stowed position without activation of the video display screen 16 to display the video images representative of the rearward view.

Optionally, the mirror head 22 may be manually movable between the deployed and stowed position. For example, the mirror assembly 20 may include a spring-loaded release mechanism such that, when the mirror head 22 is in the stowed position and the driver presses on the outer surface of the mirror casing to move the mirror head 22 further toward the overhead console 32 away from the deployed position, the mirror head 22 is released and moves to the deployed position. When the mirror head 22 is manually pivoted back to the stowed position, the mechanism retains the mirror head 22 in the stowed position and the video display screen 16 operates to display the video images again. Optionally, the manual movement of the mirror head 22 controls operation of the video display screen 16 to display video images. That is, with the mirror head 22 in the stowed position, the video display screen 16 is operated to display video images representative of the rearward field of view. Responsive to the driver manually moving the mirror head 22 to the deployed position, the video display screen 16 ceases operating to display the video images (and the video display screen may display other images or graphical displays or user interfaces, such as for the infotainment system and/or a navigation system of the vehicle). Optionally, when the mirror head 22 is manually moved to the deployed position, a locking mechanism or detent mechanism may engage to retain the mirror head 22 in the deployed position at least until video images are displayed at the video display screen 16 again.

The mirror reflective element may comprise an electrically variable reflectance electro-optic mirror reflective element, such as an electrochromic mirror reflective element, or may comprise a prismatic mirror reflective element (in such an application, the mounting structure would allow for further tilting of the mirror reflective element 26 to flip between a daytime reflectance mode and a nighttime or anti-glare reflectance mode). When the mirror head and mirror reflective element are stowed, a video feed from a rearward-viewing camera of the vehicle is provided to the video display screen 16 at the center stack 36 and video images are displayed at the video display screen to provide a rearward field of view to the driver of the vehicle. The mirror assembly 20 is stored in the overhead console or headliner 30 and the driver may opt to use the mirror assembly 20 instead of or in addition to the video display screen 16.

Furthermore, in situations when the driver cannot access the video display screen 16 on the center stack 36, such as due to failure of the video display screen 16, damage to the center stack 36, and the like, the actuator 34 may lock the mirror head 22 into the deployed position. That is, the actuator 34 or other locking mechanism may force the mirror assembly 20 to stay deployed when it is determined that the video feed is not being displayed. The actuator 34 may include a stepper motor, which allows the mirror head 22 to open and close without the need for the driver to touch the mirror head. The mirror head 22 may be locked in place, such as by the stepper motor itself or by other locking features, preventing the driver from moving the mirror head 22 to the stowed position when the video display screen 16 is not being operated. This allows for complete vehicle control of the mirror assembly 20. Optionally, the driver may select, such as via actuation of the user interface button 40 on the video display screen 16, whether to position the mirror head 22 in the deployed position or to position the mirror head 22 in the stowed position. In some examples, the driver is unable to toggle between the stowed position and the deployed position, and the mirror assembly 20 may be an emergency backup that is operated when the video display screen 16 is not displaying video images.

As discussed above, the mirror reflective element may comprise an electro-optic or electrochromic variably reflective mirror reflective element. The variably reflective mirror reflective element of the mirror assembly may utilize aspects of the mirror reflective elements described in U.S. Pat. Nos. 9,827,913; 9,174,578; 8,508,831; 8,730,553; 9,598,016; 9,346,403; 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties. Optionally, for example, the mirror reflective element may comprise a prismatic mirror assembly, and may utilize aspects of the mirror reflective elements described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606; 7,720,580; 11,165,975 and/or 11,613,209, and/or U.S. Pat. Pub. Nos. US-2006-0171704; US-2009-0244361 and/or US-2010-0214791, which are all hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the system and video display screen may be integrated with a camera monitoring system (CMS) of the vehicle. The integrated vehicle system incorporates multiple inputs, such as from an inward viewing or driver monitoring camera and from a forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The CMS cameras and system may utilize aspects of the systems described in U.S. Pat. No. 11,242,008; 10,442,360 and/or 10,046,706 and/or U.S. Publication Nos. US-2024-0064274; US-2021-0162926; US-2021-0155167; US-2019-0118717; US-2018-0134217 and/or US-2014-0285666, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular vision system, the vehicular vision system comprising:
an interior rearview mirror assembly comprising a mirror head and a mounting base, wherein the mounting base is configured to mount the interior rearview mirror assembly at an interior portion of an interior cabin of a vehicle;
wherein, with the interior rearview mirror assembly mounted at the interior portion of the interior cabin of the vehicle, the mirror head is adjustable relative to the mounting base;
wherein the mirror head accommodates a mirror reflective element;
wherein, with the interior rearview mirror assembly mounted at the interior portion of the interior cabin of the vehicle, the mirror head is adjustable between (i) a deployed position where the mirror reflective element is viewable by a driver of the vehicle and the mirror head is positioned to provide a rearward view for the driver of the vehicle and (ii) a stowed position where the mirror head is moved from the deployed position and toward the interior portion of the interior cabin of the vehicle to conceal the mirror reflective element;
a video display screen disposed within the interior cabin of the vehicle remote from the interior rearview mirror assembly, wherein the video display screen is operable to display rearview video images derived from image data captured by a rearward-viewing camera disposed at the vehicle and viewing rearward of the vehicle to provide a rearward view for viewing by the driver of the vehicle; and
wherein, responsive at least in part to determination that the mirror head is in the stowed position, the video display screen operates to display the rearview video images to provide the rearward view for viewing by the driver of the vehicle.

2. The vehicular vision system of claim 1, wherein the video display screen stops operating to display the rearview video images responsive to determination that the mirror head is moved from the stowed position to the deployed position.

3. The vehicular vision system of claim 2, wherein, responsive to determination that the mirror head is moved from the stowed position to the deployed position, the video display screen operates to display a graphical user interface.

4. The vehicular vision system of claim 1, wherein the mirror head is pivotable relative to the mounting base between the deployed position and the stowed position.

5. The vehicular vision system of claim 1, wherein an actuator is electrically operable to move the mirror head between the deployed position and the stowed position.

6. The vehicular vision system of claim 5, wherein the actuator is electrically operated to move the mirror head between the deployed position and the stowed position responsive to a user input.

7. The vehicular vision system of claim 6, wherein the user input comprises an input at a touchscreen of the video display screen.

8. The vehicular vision system of claim 5, wherein the actuator is electrically operated to move the mirror head from the stowed position to the deployed position responsive at least in part to determination that the rearview video images fail to provide the rearward view to the driver of the vehicle.

9. The vehicular vision system of claim 5, wherein, based at least in part on the video display screen being electrically operated to display the rearview video images to provide the rearward view to the driver of the vehicle, the actuator electrically operates to move the mirror head from the deployed position to the stowed position.

10. The vehicular vision system of claim 5, wherein the actuator includes a stepper motor.

11. The vehicular vision system of claim 1, wherein, with the interior rearview mirror assembly mounted at the interior portion of the interior cabin of the vehicle, and with the mirror head in the deployed position and the video display screen not operating to display the rearview video images, the mirror head is locked in the deployed position and not movable to the stowed position.

12. The vehicular vision system of claim 1, wherein, with the interior rearview mirror assembly mounted at the interior portion of the interior cabin of the vehicle, and with the mirror head in the stowed position, an outer surface of the mirror head is flush with an outer surface of the interior portion of the interior cabin of the vehicle at or near the mounting base.

13. The vehicular vision system of claim 1, wherein the interior portion of the interior cabin comprises an overhead console module of the vehicle.

14. The vehicular vision system of claim 1, wherein the interior portion of the interior cabin comprises a headliner of the vehicle.

15. The vehicular vision system of claim 1, wherein, with the interior rearview mirror assembly mounted at the interior portion of the interior cabin of the vehicle, and with the mirror head in the deployed position, the mirror head is adjustable relative to the mounting base to adjust the rearward view for the driver of the vehicle.

16. The vehicular vision system of claim 1, wherein an electronic control unit (ECU) is disposed at the vehicle, and wherein the ECU comprises electronic circuitry and associated software, and wherein the electronic circuitry of the ECU comprises an image processor operable to process image data captured by the rearward-viewing camera and transferred to the ECU.

17. The vehicular vision system of claim 16, wherein, with the interior rearview mirror assembly mounted at the interior portion of the interior cabin of the vehicle, the video display screen operates to display the rearview video images based at least in part on processing at the ECU of image data captured by the rearward-viewing camera.

18. The vehicular vision system of claim 17, wherein the video display screen operates to display the rearview video images responsive at least in part to detection of an object rearward of the vehicle via processing at the ECU of image data captured by the rearward-viewing camera.

19. A vehicular vision system, the vehicular vision system comprising:
an interior rearview mirror assembly comprising a mirror head and a mounting base, wherein the mounting base is configured to mount the interior rearview mirror assembly at an interior portion of an interior cabin of a vehicle;
wherein, with the interior rearview mirror assembly mounted at the interior portion of the interior cabin of the vehicle, the mirror head is adjustable relative to the mounting base;
wherein the mirror head accommodates a mirror reflective element;
wherein, with the interior rearview mirror assembly mounted at the interior portion of the interior cabin of the vehicle, the mirror head is adjustable between (i) a deployed position where the mirror reflective element is viewable by a driver of the vehicle and the mirror head is positioned to provide a rearward view for the driver of the vehicle and (ii) a stowed position where the mirror head is moved from the deployed position and toward the interior portion of the interior cabin of the vehicle to conceal the mirror reflective element;
wherein an actuator is electrically operable to move the mirror head between the deployed position and the stowed position;
a video display screen disposed within the interior cabin of the vehicle remote from the interior rearview mirror assembly, wherein the video display screen is operable to display rearview video images derived from image data captured by a rearward-viewing camera disposed at the vehicle and viewing rearward of the vehicle to provide a rearward view for viewing by the driver of the vehicle;
wherein, responsive at least in part to determination that the mirror head is in the stowed position, the video display screen operates to display the rearview video images to provide the rearward view for viewing by the driver of the vehicle; and
wherein the video display screen stops operating to display the rearview video images responsive to determination that the mirror head is moved from the stowed position to the deployed position.

20. The vehicular vision system of claim 19, wherein, responsive to determination that the mirror head is moved from the stowed position to the deployed position, the video display screen operates to display a graphical user interface.

21. The vehicular vision system of claim 19, wherein the actuator is electrically operated to move the mirror head between the deployed position and the stowed position responsive to a user input.

22. The vehicular vision system of claim 21, wherein the user input comprises an input at a touchscreen of the video display screen.

23. The vehicular vision system of claim 19, wherein the actuator is electrically operated to move the mirror head from the stowed position to the deployed position responsive at least in part to determination that the rearview video images fail to provide the rearward view to the driver of the vehicle.

24. The vehicular vision system of claim 19, wherein, based at least in part on the video display screen being electrically operated to display the rearview video images to provide the rearward view to the driver of the vehicle, the actuator electrically operates to move the mirror head from the deployed position to the stowed position.

25. The vehicular vision system of claim 19, wherein the actuator includes a stepper motor.

26. The vehicular vision system of claim 19, wherein the interior portion of the interior cabin comprises one selected from the group consisting of (i) an overhead console module of the vehicle, a headliner of the vehicle and (iii) a windshield electronics module of the vehicle.

27. A vehicular vision system, the vehicular vision system comprising:
an interior rearview mirror assembly comprising a mirror head and a mounting base, wherein the mounting base is configured to mount the interior rearview mirror assembly at an interior portion of an interior cabin of a vehicle;
wherein the interior portion of the interior cabin comprises one selected from the group consisting of (i) an overhead console module of the vehicle, a headliner of the vehicle and (iii) a windshield electronics module of the vehicle;
wherein, with the interior rearview mirror assembly mounted at the interior portion of the interior cabin of the vehicle, the mirror head is adjustable relative to the mounting base;
wherein the mirror head accommodates a mirror reflective element;
wherein, with the interior rearview mirror assembly mounted at the interior portion of the interior cabin of the vehicle, the mirror head is adjustable between (i) a deployed position where the mirror reflective element is viewable by a driver of the vehicle and the mirror head is positioned to provide a rearward view for the driver of the vehicle and (ii) a stowed position where the mirror head is moved from the deployed position and toward the interior portion of the interior cabin of the vehicle to conceal the mirror reflective element;
a video display screen disposed within the interior cabin of the vehicle remote from the interior rearview mirror assembly, wherein the video display screen is operable to display rearview video images derived from image data captured by a rearward-viewing camera disposed at the vehicle and viewing rearward of the vehicle to provide a rearward view for viewing by the driver of the vehicle;
wherein, responsive at least in part to determination that the mirror head is in the stowed position, the video display screen operates to display the rearview video images to provide the rearward view for viewing by the driver of the vehicle; and
wherein, with the interior rearview mirror assembly mounted at the interior portion of the interior cabin of the vehicle, the video display screen operates to display the rearview video images based at least in part on processing by an image processor of image data captured by the rearward-viewing camera.

28. The vehicular vision system of claim 27, wherein the video display screen stops operating to display the rearview video images responsive to determination that the mirror head is moved from the stowed position to the deployed position.

29. The vehicular vision system of claim 27, wherein, with the interior rearview mirror assembly mounted at the interior portion of the interior cabin of the vehicle, and with the mirror head in the deployed position, the mirror head is adjustable relative to the mounting base to adjust the rearward view for the driver of the vehicle.

30. The vehicular vision system of claim 27, wherein the video display screen operates to display the rearview video images responsive at least in part to detection of an object rearward of the vehicle via processing by the image processor of image data captured by the rearward-viewing camera.
